(19) United States
(12) Patent Application Publication
(10) Pub. No.: US 2024/0023170 A1
(43) Pub. Date: Jan. 18, 2024

(54) METHODS, DEVICES, AND SYSTEMS FOR CALCULATING AND CONFIGURING RANDOM ACCESS CHANNEL

(71) Applicant: ZTE Corporation, Shenzhen (CN)

(72) Inventors: Juan LIU, Shenzhen (CN); Li TIAN, Shenzhen (CN); Li ZHANG, Shenzhen (CN)

(73) Assignee: ZTE Corporation, Shenzhen (CN)

(21) Appl. No.: 18/475,541

(22) Filed: Sep. 27, 2023

Related U.S. Application Data
(63) Continuation of application No. PCT/CN21/85328, filed on Apr. 2, 2021.

(51) Int. Cl. H04W 74/08; H04L 27/26

(52) U.S. Cl. CPC H04W 74/0833; H04L 27/26025

(57) ABSTRACT

The present disclosure describes methods, systems and devices for calculating and configuring a random access channel (RACH). One method includes configuring, by a base station, a physical random access channel (PRACH) occasion corresponding to a user equipment (UE) at least by one of the following: configuring, by the base station, a set of parameters; calculating, by the base station, a radio network temporary identifier (RNTI) based on the set of parameters or the PRACH occasion in which a random access preamble is transmitted; and transmitting, by the base station, the set of parameters to the UE for the PRACH occasion in which a random access preamble is transmitted.

### TECHNICAL FIELD

The present disclosure is directed generally to wireless communications. Particularly, the present disclosure relates to methods, devices, and systems for calculating and configuring a random access channel (RACH).

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

For the new generation mobile communication technology, a base station and/or a user equipment need to configure signal resource for a physical random access channel (PRACH). There are several issues/problems with the existing system for configuring signal resources for PRACH. For example, for high carrier frequency, a channel bandwidth may be wider than new radio (NR), a new subcarrier spacing maybe introduced; and a problem/issue of how to calculate a radio network temporary identifier (RNTI).

The present disclosure describes various embodiment for calculating and configuring a random access channel (RACH) occasion, addressing at least some of issues/problems associated with the existing system to improve the performance of the wireless communication.

### SUMMARY

This document relates to methods, systems, and devices for wireless communication, and more specifically, for calculating and configuring a random access channel (RACH).

In one embodiment, the present disclosure describes a method for wireless communication. The method includes configuring, by a base station, a physical random access channel (PRACH) occasion corresponding to a user equipment (UE) at least by one of the following: configuring, by the base station, a set of parameters; calculating, by the base station, a radio network temporary identifier (RNTI) based on the set of parameters or the PRACH occasion in which a random access preamble is transmitted; and transmitting, by the base station, the set of parameters to the UE for the PRACH occasion in which a random access preamble is transmitted.

In another embodiment, the present disclosure describes a method for wireless communication. The method includes configuring a user equipment (UE) for a physical random access channel (PRACH) occasion by a base station at least by one of the following: receiving, by the UE, a set of parameters from the base station for the PRACH occasion in which a random access preamble is transmitted; calculating, by the UE, a radio network temporary identifier (RNTI) based on the set of parameters or the PRACH occasion in which a random access preamble is transmitted.

In another embodiment, the present disclosure describes a method for wireless communication. The method includes transmitting a set of parameters from a base station to a user equipment (UE) for a physical random access channel (PRACH) occasion, the set of parameters comprising at least one of at least one least significant bit (LSB) of a system frame number (SFN) or a segment index, by independently transmitting at least one of the at least one LSB of the SFN or the segment index from the base station to the UE.

In another embodiment, the present disclosure describes a method for wireless communication. The method includes transmitting a set of parameters from a base station to a user equipment (UE) for a physical random access channel (PRACH) occasion, the set of parameters comprising at least one of at least one least significant bit (LSB) of a system frame number (SFN) or a segment index, by: dependently transmitting at least one of the at least one LSB of the SFN and the segment index from the base station to the UE.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4 shows a flow diagram of a method for wireless communication.

FIG. 5 shows a flow diagram of a method for wireless communication.

FIG. 6A shows a schematic diagram of a method for wireless communication.

FIG. 6B shows a schematic diagram of a method for wireless communication.

FIG. 7 shows a schematic diagram of a method for wireless communication.

FIG. 8 shows a schematic diagram of a method for wireless communication.

FIG. 9 shows a flow diagram of a method for wireless communication.

FIG. 10 shows a schematic diagram of a method for wireless communication.

FIG. 11 shows a schematic diagram of a method for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for calculating and configuring a random access channel (RACH).

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

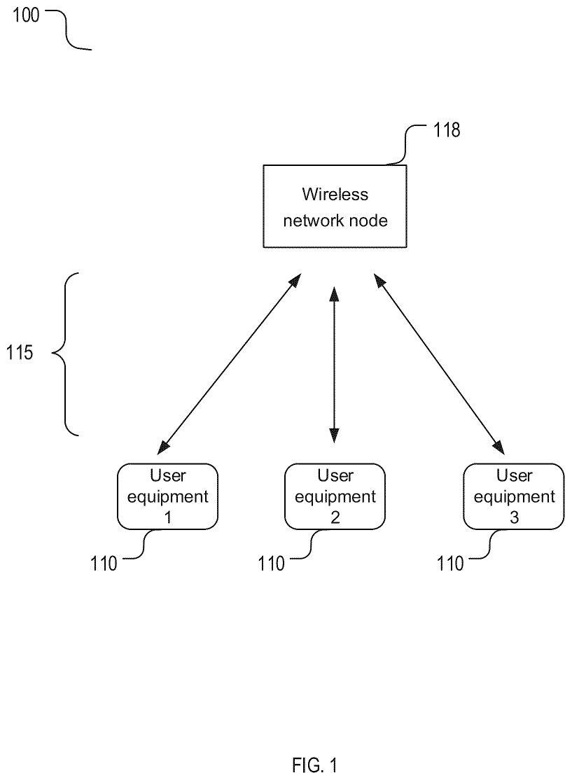

The present disclosure describes various embodiments for transmitting initial access information to a user equipment. FIG. 1 shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115. For example, a first UE 110 may wirelessly communicate with a wireless network node 118 via a channel including a plurality of radio channels during a certain period of time. The network base station 118 may configure PRACH transmission parameters to the UE 110. The UE 110 may receive physical random access channel (PRACH) transmission parameters (for example but not limited to, PRACH preamble format, time resources, and frequency resources for PRACH transmission).

For the 5th Generation mobile communication technology, a base station and/or a user equipment need to configure signal resource for a physical random access channel (PRACH). There are several issues/problems with the existing system for configuring signal resources for PRACH. For example, some of the issues/problems are associated with new subcarrier spacing (SCS) for a channel bandwidth being wider in high carrier frequency. Another of the issues/problems is, for a new subcarrier spacing introduced, how to calculate a radio network temporary identifier (RNTI). The present disclosure may address at least some of issues/problems associated with the existing system to improve the performance of the wireless communication.

In various embodiments, a max number for a slot number in a radio or system frame may be relatively larger, for example, the number is 640 when SCS equals to 960 kilohertz (kHz). The function for calculating a radio network temporary identifier (RNTI) may need to change.

In some embodiments, the RNTI may include a random Access radio network temporary identifier (RA-RNTI). The function to calculate the RA-RNTI may be RA-RNTI=1+s_id+14×t_id+14×80×f_id+14×80×8×ul_carrier_id, wherein s_id is the index of the first OFDM symbol of the PRACH occasion (0≤s_id<14); t_id is the index of the first slot of the PRACH occasion in a system frame (0≤t_id<80), where it is determined by the value of μ(related to SCS).

For the t_id number is larger than 80 if the PRACH subcarrier spacing (SCS) is larger than 120 kHz, the present disclosure describes some embodiment for designing the RA-RNTI value to insure it not exceeds the maximum value.

In some embodiments, the RNTI may include a msg-B radio network temporary identifier (MSGB-RNTI), which is associated with the PRACH occasion in which a random access preamble is transmitted. The MSGB-RNTI may be computed as MSGB-RNTI=1+s_id+14×t_id+14×80×f_id+14×80×8×ul_carrier_id+14×80×8×2, where s_id is the index of the first OFDM symbol of the PRACH occasion (0≤s_id<14), t_id is the index of the first slot of the PRACH occasion in a system frame (0≤t_id<80), where the subcarrier spacing to determine t_id is based on the value of μ specified, f_id is the index of the PRACH occasion in the frequency domain (0≤f_id<8), and ul_carrier_id is the UL carrier used for Random Access Preamble transmission (0 for NUL carrier, and 1 for SUL carrier).

In some embodiments for 5G NR, if the RA window>10 ms for 4 step and 2 step RACH, a downlink control information (DCI) 1_0 may include zero or at least one significant bits (LSBs) of a system frame number (SFN). The LSB of the SFN may include 2 bits for the DCI format 1_0 with cyclic redundancy check (CRC) scrambled by MsgB-RNTI if msgB-response Window is configured to be larger than 10 millisecond (ms). The LSB of the SFN may include 2 bits for the DCI format 1_0 with CRC scrambled by RA-RNTI for operation in a cell with shared spectrum channel access if ra-Response Window or ra-ResponseWindow-v1610 is configured to be larger than 10 ms. The LSB of the SFN may include 0 bit in other situations, for example, when msgB-responseWindow is configured to be equal to or smaller than 10 ms.

In some embodiments, the new PRACH subcarrier spacing maybe introduced, and thus, the function to calculate RA-RNTI and/or MSGB-RNTI may need changed and new rules for the calculation may be created accordingly.

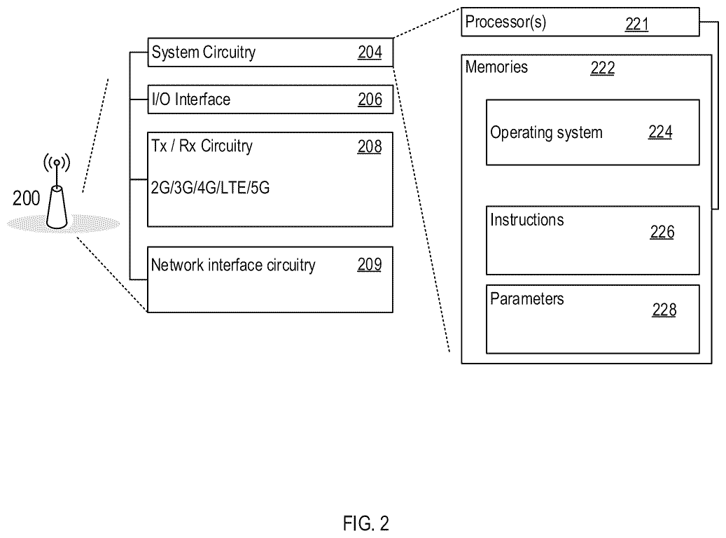

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

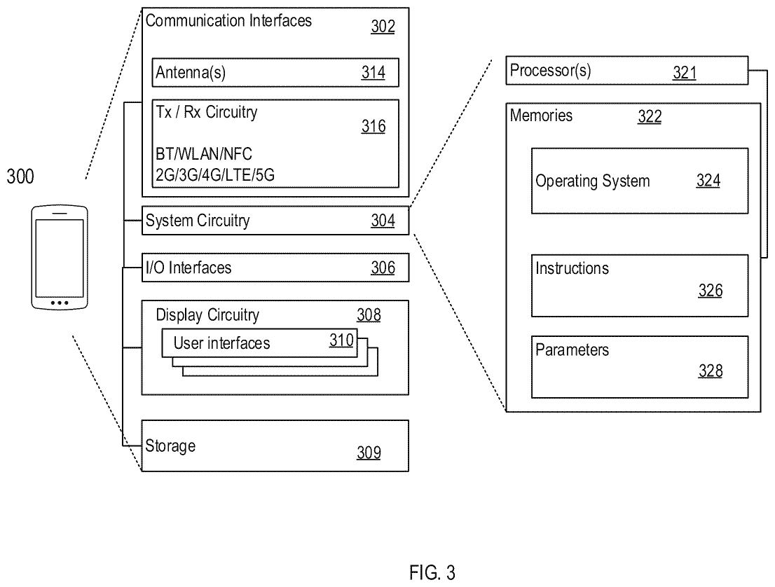

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE) , and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

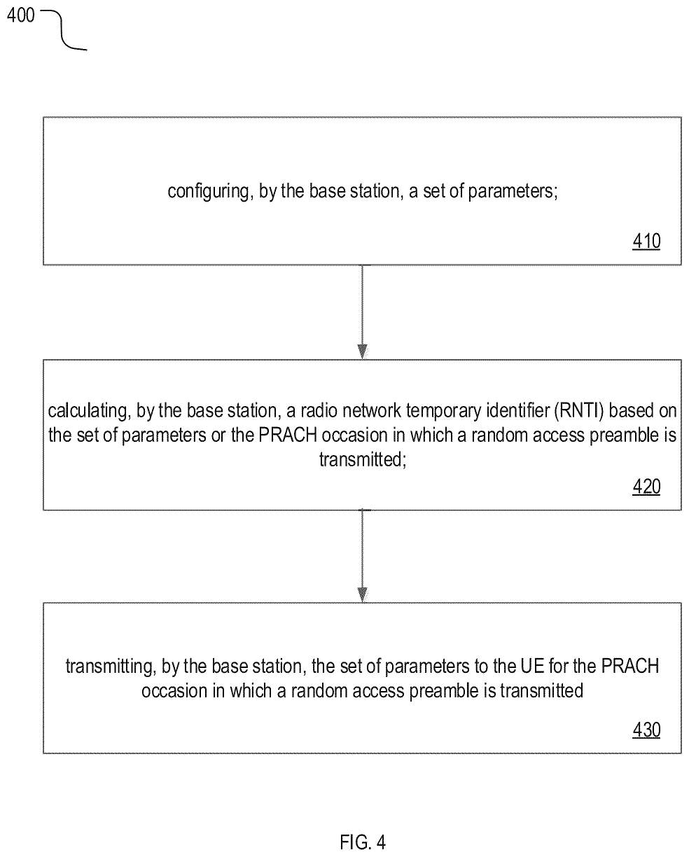

Referring to FIG. 4, the present disclosure describes embodiments of a method 400 for configuring, by a base station, a physical random access channel (PRACH) occasion corresponding to a user equipment (UE). The method 400 may include at least one of the following steps: step 410, configuring, by the base station, a set of parameters; step 420, calculating, by the base station, a radio network temporary identifier (RNTI) based on the set of parameters or the PRACH occasion in which a random access preamble is transmitted; and step 430, transmitting, by the base station, the set of parameters to the UE for the PRACH occasion in which a random access preamble is transmitted.

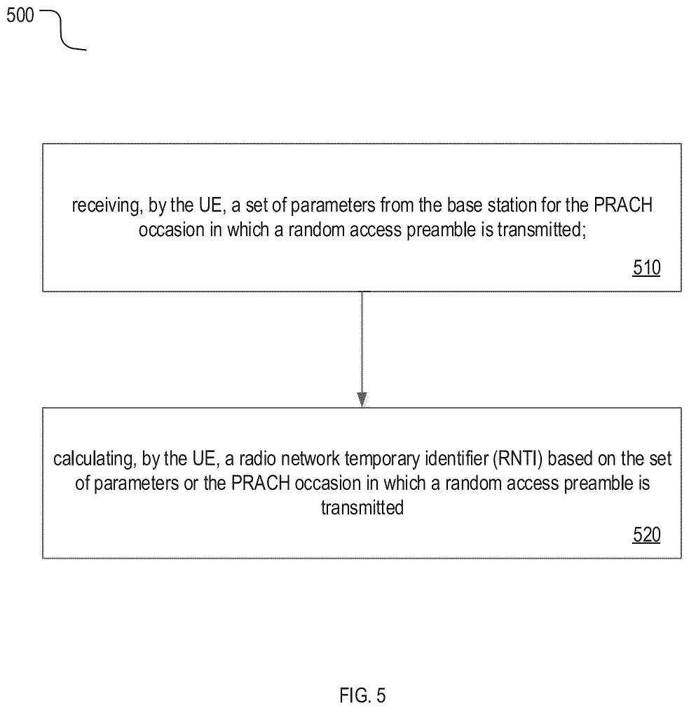

Referring to FIG. 5, the present disclosure describes embodiments of a method 500 for configuring a user equipment (UE) for a physical random access channel (PRACH) occasion by a base station. The method 500 includes at least one of the following steps: step 510, receiving, by the UE, a set of parameters from the base station for the PRACH occasion in which a random access preamble is transmitted; step 520, calculating, by the UE, a radio network temporary identifier (RNTI) based on the set of parameters or the PRACH occasion in which a random access preamble is transmitted.

In one implementation, the RNTI comprises at least one of the following: a random access RNTI (RA-RNTI) corresponding to a 4-step random access (RA) process, or a MSGB-RNTI corresponding to a 2-step RA process.

In another implementation, the set of parameters comprising an index corresponding to the PRACH occasion in which the random access preamble is transmitted and at least one of the following: at least one least significant bit (LSB) of a system frame number (SFN); or a segment index.

In another implementation, a PRACH subcarrier spacing (SCS) corresponding to the PRACH occasion comprises at least one of the following: 15 kHz, 30 kHz, 60 kHz, 120 kHz, 240 kHz, 480 kHz, or 960*M kHz, wherein M is a positive integer; and a specific SCS of a reference slot corresponding to the PRACH occasion comprises at least one of the following: 15 kHz, 30 kHz, 60 kHz, 120 kHz, 240 kHz, 480 kHz, or 960*P kHz, wherein P is a positive integer.

In another implementation, a specific time duration corresponding to the PRACH occasion comprises at least one of the following: a duration of a single slot for a SCS being 15 kHz, 30 kHz, 60 kHz, 120 kHz, 240 kHz, 480 kHz, or 960*K kHz, wherein K is a positive integer, a system frame, a random access response (RAR) window size, or N slots with a SCS being 15 kHz, 30 kHz, 60 kHz, 120 kHz, 240 kHz, 480 kHz, or 960*K kHz, wherein K is a positive integer and N is a positive integer.

In various embodiments, each segment in a specific time duration comprises N slots, wherein N equals to one of 80*{1, 2, 3, 4, 6, 8, 12, 16}; and the set of parameters comprises the at least one LSB of the SFN and the segment index.

In one implementation, the index corresponding to the PRACH occasion comprises an index of the first slot of PRACH occasion in which a random access preamble is transmitted in a segment.

In another implementation, the index corresponding to the PRACH occasion comprises a logic RACH occasion (RO) index in a segment.

In another implementation, in response to a PRACH SCS being 120 kHz, a system frame comprises one segment; in response to the PRACH SCS being 240 kHz, the system frame comprises two segments; in response to the PRACH SCS being 480 kHz, the system frame comprises four segments; and in response to the PRACH SCS being 960 kHz, the system frame comprises eight segments.

In another implementation, a transmission of the set of parameters comprises at least one of the following: the at least one LSB of the SFN and the segment index; the segment index alone; the at least one LSB of the SFN alone; or neither the at least one LSB of the SFN nor the segment index.

In another implementation, each segment refer to a PRACH slot; the segment index indicates a slot index in a slot with a SCS being 120 kHz; and the set of parameters comprises the at least one LSB of the SFN and the segment index.

In another implementation, the transmission of the set of parameters comprises at least one of the following: downlink control information (DCI), or random access response (RAR).

In another implementation, the RNTI, for example, RA-RNTI or MSGB-RNTI in a segment may be calculated based on t_id being the index of the PRACH occasion in the time zone (i.e., a segment).

In another implementation, a segment index in the signaling information may be introduced. For example, there are 2 segments in a radio frame (or system frame) when the PRACH SCS is 240 kHz; there are 4 segments in a radio frame if the PRACH SCS is 480 kHz; and there are 8 segments in a radio frame if the PRACH SCS is 960 kHz.

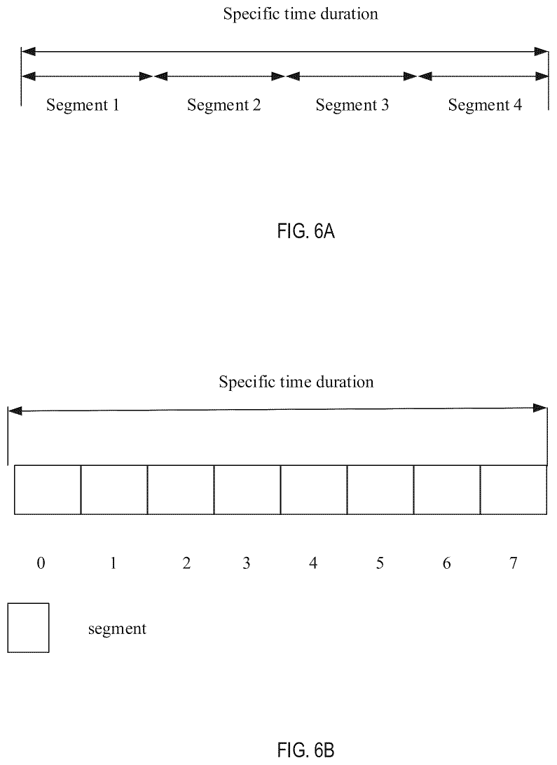

As shown in FIG. 6A, four segments are included in a specific time duration, which may refer to a radio frame for a specific PRACH SCS, for example, when the PRACH SCS is 480 kHz.

As shown in FIG. 6B, eight segments are included in a specific time duration, which may refer to a radio frame for a specific PRACH SCS, for example, when the PRACH SCS is 960.

Each segment may contain N slots; for example, typically N is one of 80*{1, 2, 3, 4, 6, 8, 12, 16}.

In another implementation, the LSB of the SFN and the segment index maybe signaled by control information, for example, a DCI or a RAR.

In various embodiments, the RNTI in a segment may be calculated and the t_id index may be a logic RO index in the time zone (i.e., a segment).

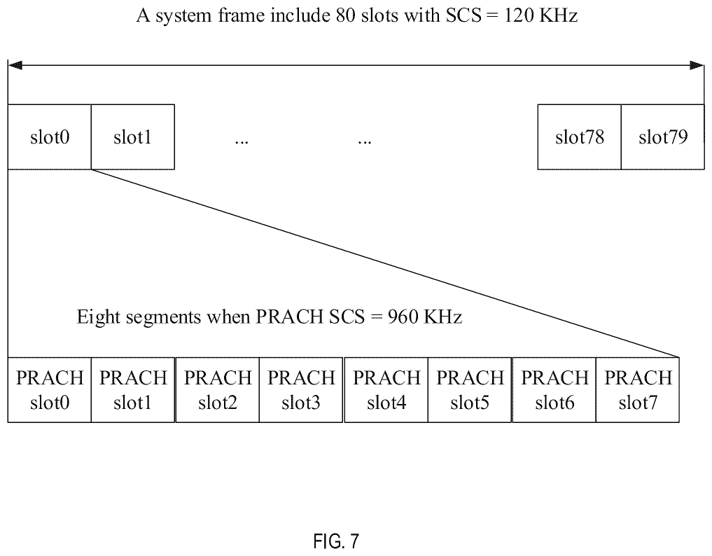

FIG. 7 shows an example of the segment referring to a PRACH slot, and the segment index refer to the slot index in a slot for a PRACH SCS being 120 kHz.

In various embodiments, the index corresponding to the PRACH occasion in which a random access preamble is transmitted comprises a logic RACH occasion (RO) index in a RA window duration.

In one implementation, the step of calculating the RNTI based on the set of parameters or the index corresponding to the PRACH occasion in which a random access preamble is transmitted may include calculating the RNTI based on 14*t, wherein t is the index corresponding to the PRACH occasion.

In one or more embodiments, the RNTI in a RA window size may be calculated and the t_id index may be a logic RO index in a time zone (i.e., a RA window duration).

In one implementation, the calculation of RA-RNTI may be as RA-RNTI=1+s_id+14×t_id+14×80×f_id+14×80×8×ul_carrier_id, where s_id is the index of the first OFDM symbol of the PRACH occasion (0≤s_id<14), and t_id is the logical index of the PRACH occasion in a RA window size.

In another implementation, the calculation of MSGB-RNTI may be as MSGB-RNTI=1+s_id+14×t_id+14×80×f_id+14×80×8×ul_carrier_id+14×80×8×2, where s_id is the index of the first OFDM symbol of the PRACH occasion (0≤s_id<14), t_id is the index of the logical index of the PRACH occasion.

In another implementation, no further parameter need to be signaled from the base station to the UE.

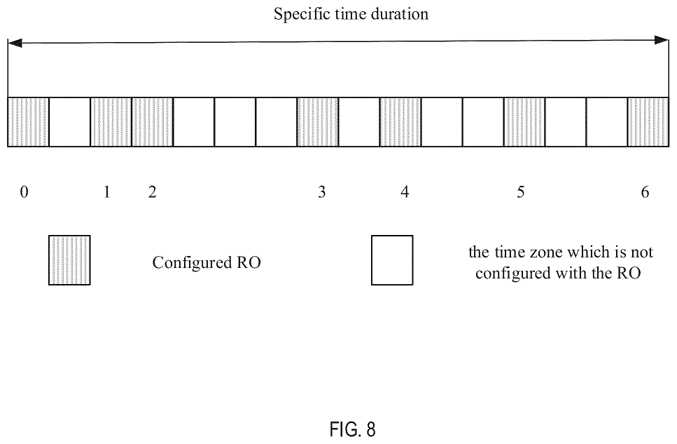

FIG. 8 shows an example of a logical index of the PRACH occasion, where the logical index may include any one or all of 0, 1, 2, 3, 4, 5, 6, 7. In other implementations, the logical index of the PRACH occasions may include any integer between 0 and 79, inclusive.

In various embodiments, the index corresponding to the PRACH occasion comprises at least one of the following: a logic index of the PRACH occasion in a special time duration; an index of a first slot of the PRACH occasion in a system frame; or an index of a first slot of the PRACH occasion in the special time duration.

In one implementation, a specific time duration corresponding to the PRACH occasion comprises at least one of the following: a duration of a RA window; or a N*system frame, wherein N is a positive integer.

In another implementation, the step of calculating the RNTI based on the set of parameters or the index corresponding to the PRACH occasion in which a random access preamble is transmitted may include calculating the RNTI based on 14*mod(t, 80), wherein t is the index corresponding to the PRACH occasion and the mod is a modular operation.

In another implementation, in response to the index corresponding to the PRACH occasion comprising the logic index of the PRACH occasion in the special time duration: in response to the PRACH occasion in which the random access preamble is transmitted, at least one of following parameter is transmitted from the base station to the UE: the segment index, or the at least one LSB of the SFN.

In another implementation, in response to the index corresponding to the PRACH occasion comprising the index of the first slot of the PRACH occasion in the system frame, the segment index is excluded from being transmitted from the base station to the UE; and in response to the index corresponding to the PRACH occasion comprising the index of the first slot of the PRACH occasion in the special time duration, at least one of following parameter is transmitted from the base station to the UE: the segment index or the at least one LSB of the SFN.

In various embodiments, the RNTI in a special time duration may be calculated. The RNTI may include at least one of RA-RNTI and/or MSGB-RNTI.

In one implementation, t_id is the logical index of the PRACH occasion in a special time duration.

In another implementation, t_id is the index of the first slot of the PRACH occasion in a system frame.

In another implementation, t_id is the index of the first slot of the PRACH occasion in a special time duration.

In another implementation, the calculation of RA-RNTI may be as RA-RNTI=1+s_id+14×nmod(t_id, 80)+14×80×f_id+14×80×8×ul_carrier_id.

In another implementation, the calculation of MSGB-RNTI may be as MSGB-RNTI=1+s_id+14×mod(t_id, 80)+14×80×f_id+14×80×8×ul_carrier_id+14×80×8×2.

In another implementation, there may be only one segment being valid or configured in a special time duration, for example but not limited to, a slot duration for SCS equals to 120 kHz, a radio frame, segment being a slot duration of a SCS being one of 120 kHz , 240 kHz, 480 kHz, or 960 kHz.

In one implementation, the different reference of t_id may correspond to different information signaling.

In another implementation, for a special time duration, the information signaling may indicate a segment and a LSB.

In another implementation, for a system frame, the information signaling may indicate a LSB, but does not need to indicate a segment.

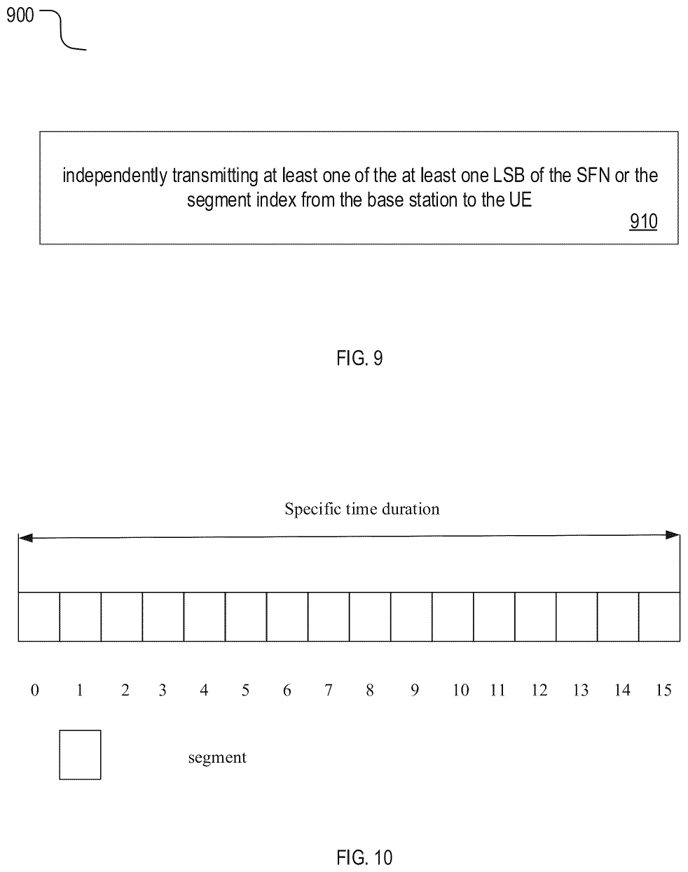

Referring to FIG. 9, the present disclosure describes embodiments of a method 900 for transmitting a set of parameters from a base station to a user equipment (UE) for a physical random access channel (PRACH) occasion. In one implementation, the set of parameters comprising at least one of at least one least significant bit (LSB) of a system frame number (SFN) or a segment index. The method 900 may include step 910, independently transmitting at least one of the at least one LSB of the SFN or the segment index from the base station to the UE.

In one implementation, in response to a RA window being larger than 10 milliseconds, the at least one LSB of the SFN comprises N bits, wherein N being at least one of the following: two bits; or zero bit in response to the RA window being smaller than or equal to 10 milliseconds, one bit in response to the RA window being 20 milliseconds and two bits in response to the RA window being larger than 20 milliseconds.

In another implementation, the segment index comprises at least one of the following: three bits; or zero bit in response to a PRACH SCS being smaller than or equal to 120 kHz, one bit in response to the PRACH SCS being equal to 240 kHz, two bits in response to the PRACH SCS being equal to 480 kHz, and three bits in response to the PRACH SCS being equal to 960 kHz.

In another implementation, the segment index comprises N bits, wherein: N=log2(M/120), M being the PRACH SCS in a unit of kHz.

The present disclosure describes various embodiments for signaling the information from the base station to the UE.

In one implementation, the base station may inform the LSB of SFN and segment index independently to the UE.

In another implementation, the base station may inform to the UE the LSB of SFN if RA window>10 ms; 1 bit corresponding to a 20 ms RA window; and 2 bits corresponding to a 30 or 40 ms RA window.

In another implementation, the base station may inform 2 bit for all cases to the UE.

In another implementation, the base station may inform the segment index, 0 bit corresponding to a PRACH SCS<=120 kHz; 1 bit corresponding to a PRACH SCS=240 kHz; 2 bits corresponding to a PRACH SCS=480 kHz; 3 bits corresponding to a PRACH SCS=960 kHz. In another implementation, the base station may inform 3 bits for all cases.

In various embodiments, the step of transmitting the set of parameters from the base station to the UE for the PRACH occasion may include at least one of the following: in response to a RA window is larger than 10 milliseconds and a PRACH SCS being smaller than or equal to 120 kHz, transmitting the at least one LSB of the SFN from the base station to the UE; in response to the RA window is larger than 10 milliseconds and the PRACH SCS being larger than 120 kHz, transmitting the at least one LSB of the SFN and the segment index from the base station to the UE; in response to the RA window is larger than 10 milliseconds and the PRACH SCS being larger than 120 kHz, transmitting the at least one LSB of the SFN from the base station to the UE; in response to the RA window is smaller than or equal to 10 milliseconds and the PRACH SCS being smaller than or equal to 120 kHz, transmitting neither the at least one LSB of the SFN nor the segment index from the base station to the UE; in response to the RA window is smaller than or equal to 10 milliseconds and the PRACH SCS being larger than 120 kHz, transmitting the segment index from the base station to the UE; in response to the RA window is smaller than or equal to 10 milliseconds and the PRACH SCS being larger than 120 kHz, transmitting neither the at least one LSB of the SFN nor the segment index from the base station to the UE; and in response to the RA window and PRACH SCS, transmitting at least one LSB of the SFN and the segment index from the base station; in response to the RA window and the PRACH SCS, transmitting the at least one LSB of the SFN from the base station to the UE; in response to the RA window and the PRACH SCS, transmitting neither the at least one LSB of the SFN nor the segment index from the base station to the UE; in response to the RA window and the PRACH SCS , transmitting the segment index from the base station to the UE.

In one implementation, the at least one LSB of the SFN and the segment index comprises N bits, wherein N is one of 2, 3, 4, or 5 based on the RA window and the PRACH SCS.

The present disclosure describes one or more example for various embodiments of informing the LSB of SFN and segment index dependently from the base station to the UE.

In case 1, when RA window>10 ms and PRACH SCS<=120 kHz, only LSB of SFN is informed.

In case 2, when RA window>10 ms and PRACH SCS>120 kHz, both LSB of SFN and segment index are informed.

In case 3, when RA window<=10 ms and PRACH SCS<=120 kHz, none is informed.

In case 4, when RA window<=10 ms and PRACH SCS>120 kHz, only segment index is informed.

In one implementation, 5 bits are informed by the base station for all cases. In another implementation, N bits are informed by the base station for all cases, wherein N may be any integer between 0 and 5, inclusive, and N may be the values as showed in Table 1, and ‘/’ refers to ‘or’ in Table 1.

TABLE 1
Number of bits from the base station to the UE

| Index | RA window | PRACH SCS | Number of bits |
|---|---|---|---|
| 0 | 10 ms | 120 kHz | 0 bit/3 bit/5 bit |
| 1 | 10 ms | 240 kHz | 1 bit/3 bit/5 bit |
| 2 | 10 ms | 480 kHz | 2 bit/3 bit/5 bit |
| 3 | 10 ms | 960 kHz | 3 bit/5 bit |
| 4 | 20 ms | 120 kHz | 1 bit/4 bit/5 bit |
| 5 | 20 ms | 240 kHz | 2 bit/4 bit/5 bit |
| 6 | 20 ms | 480 kHz | 3 bit/4 bit/5 bit |
| 7 | 20 ms | 960 kHz | 4 bit/5 bit |
| 8 | 30 ms | 120 kHz | 2 bit/5 bit |
| 9 | 30 ms | 240 kHz | 3 bit/5 bit |
| 10 | 30 ms | 480 kHz | 4 bit/5 bit |
| 11 | 30 ms | 960 kHz | 5 bit/5 bit |
| 12 | 40 ms | 120 kHz | 2 bit/5 bit |
| 13 | 40 ms | 240 kHz | 3 bit/5 bit |
| 14 | 40 ms | 480 kHz | 4 bit/5 bit |
| 15 | 40 ms | 960 kHz | 5 bit |

In another implementation, the index order in Table 1 may be combined in any order.

For one example as shown in FIG. 10, when a RA window=20 ms and a PRACH SCS=960 kHz, a special time duration may refer to 20 ms, and include sixteen segments. Each segment may contain 80 slots. The index of each of the segments are showed in FIG. 10. There may be 4 bits needed for indicating the index of the segments. This case corresponding to the Table 1 with ‘Index’ equals to 7, the ‘RA window’ equals to 20 ms, ‘PRACH SCS’ equals to 960 kHz, ‘Number of bits’ equals to 4 bit.

For the first segment, the 4 bits may be ‘0000’.

For the second segment, the 4 bits may be ‘0001’, and so on.

For the sixteenth segment, the 4 bits may be ‘1111’.

In various embodiments, the at least one LSB of the SFN and the segment index may include five bits.

In one implementation, the base station may inform the LSB of SFN and segment index dependently to the UE.

In another implementation, 5 bits are informed by the base station for all cases. In another implementation, N bits are informed by the base station for all cases, wherein N may be any integer between 0 and 5, inclusive, and N may be the values as showed in Table 1.

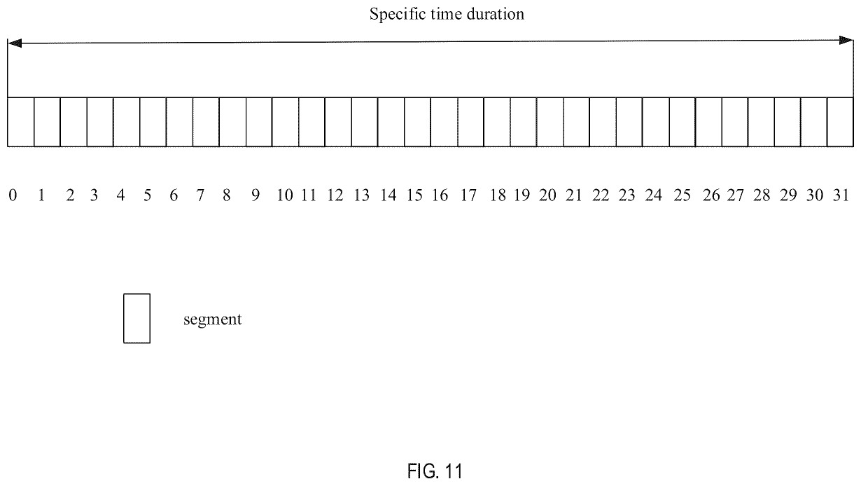

For another example as shown in FIG. 11, when a RA window=40 ms and a PRACH slot=960 kHz, a special time duration may refer to 40 ms, and may include thirty-two segments in 40 ms. Each segment may contains 80 slots. The index of the segments are showed in FIG. 11. There may be 5 bits needed for indicating the index of the segments. This case corresponding to the Table 1 with ‘Index’ equals to 15, the ‘RA window’ equals to 40 ms, ‘PRACH SCS’ equals to 960 kHz, ‘Number of bits’ equals to 5 bit.

For the first segment, the 5 bits may be ‘00000’.

For the second segment, the 5 bits may be ‘00001’, and so on.

For the sixteen segment, the 5 bits maybe ‘01111’, and so on.

For the thirty-second segment, the 5 bits may be ‘11111’.

The present disclosure describes methods, apparatus, and computer-readable medium for wireless communication. The present disclosure addressed the issues with calculating and configuring a random access channel (RACH). The methods, devices, and computer-readable medium described in the present disclosure may facilitate the performance of wireless transmission between a user equipment and a base station, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
configuring, by a base station, a physical random access channel (PRACH) occasion corresponding to a user equipment (UE) at least by one of the following:
configuring, by the base station, a set of parameters; and
calculating, by the base station, a radio network temporary identifier (RNTI) based on the set of parameters or the PRACH occasion in which a random access preamble is transmitted.

2. (canceled)

3. The method according to claim 1, wherein:
the RNTI comprises at least one of the following:
a random access RNTI (RA-RNTI) corresponding to a 4-step random access (RA) process, or
a MSGB-RNTI corresponding to a 2-step RA process.

4. The method according to claim 1, wherein:
the set of parameters comprising an index corresponding to the PRACH occasion in which the random access preamble is transmitted and at least one of the following:
at least one least significant bit (LSB) of a system frame number (SFN); or
a segment index.

5. The method according to claim 4, wherein:
a PRACH subcarrier spacing (SCS) corresponding to the PRACH occasion comprises at least one of the following: 15 kHz, 30 kHz, 60 kHz, 120 kHz, 240 kHz, 480 kHz, or 960*M kHz, wherein M is a positive integer; and
a specific SCS of a reference slot corresponding to the PRACH occasion comprises at least one of the following: 15 kHz, 30 kHz, 60 kHz, 120 kHz, 240 kHz, 480 kHz, or 960*P kHz, wherein P is a positive integer.

6. The method according to claim 4, wherein:
a specific time duration corresponding to the PRACH occasion comprises at least one of the following:
a duration of a single slot for a SCS being 15 kHz, 30 kHz, 60 kHz, 120 kHz, 240 kHz, 480 kHz, or 960*K kHz, wherein K is a positive integer,
a system frame,
a random access response (RAR) window size, or
N slots with a SCS being 15 kHz, 30 kHz, 60 kHz, 120 kHz, 240 kHz, 480 kHz, or 960*K kHz, wherein K is a positive integer and N is a positive integer.

7. The method according to claim 4, wherein:
each segment in a specific time duration comprises N slots, wherein N equals to one of 80*{1, 2, 3, 4, 6, 8, 12, 16}; and
the set of parameters comprises the at least one LSB of the SFN and the segment index.

8. The method according to claim 7, wherein:
the index corresponding to the PRACH occasion comprises an index of a first slot of PRACH occasion in which a random access preamble is transmitted in a segment.

9. The method according to claim 7, wherein:
the index corresponding to the PRACH occasion comprises a logic RACH occasion (RO) index in a segment.

10. The method according to claim 8, wherein:
in response to a PRACH SCS being 120 kHz, a system frame comprises one segment;
in response to the PRACH SCS being 240 kHz, the system frame comprises two segments;
in response to the PRACH SCS being 480 kHz, the system frame comprises four segments; and
in response to the PRACH SCS being 960 kHz, the system frame comprises eight segments.

11. The method according to claim 8, wherein:
a transmission of the set of parameters comprises at least one of the following:
the at least one LSB of the SFN and the segment index;
the segment index alone;
the at least one LSB of the SFN alone; or
neither the at least one LSB of the SFN nor the segment index.

12. The method according to claim 4, wherein:
each segment refer to a PRACH slot;
the segment index indicates a slot index in a slot with a SCS being 120 kHz; and
the set of parameters comprises the at least one LSB of the SFN and the segment index.

13. The method according to claim 12, wherein:
a transmission of the set of parameters comprises at least one of the following:
downlink control information (DCI), or
random access response (RAR).

14. The method according to claim 1, wherein:
an index corresponding to the PRACH occasion in which a random access preamble is transmitted comprises a logic RACH occasion (RO) index in a RA window duration.

15. The method according to claim 7, wherein the calculating the RNTI based on the set of parameters or the index corresponding to the PRACH occasion in which a random access preamble is transmitted comprises:
calculating the RNTI based on 14*t, wherein t is the index corresponding to the PRACH occasion.

16. The method according to claim 4, wherein:
the index corresponding to the PRACH occasion comprises at least one of the following:
a logic index of the PRACH occasion in a special time duration;
an index of a first slot of the PRACH occasion in a system frame; or
an index of a first slot of the PRACH occasion in the special time duration.

17. The method according to claim 16, wherein:
a specific time duration corresponding to the PRACH occasion comprises at least one of the following:
a duration of a RA window; or
a N*system frame, wherein N is a positive integer.

18-29. (canceled)

30. An apparatus comprising:
a memory storing instructions; and
a processor in communication with the memory, wherein, when the processor executes the instructions, the processor is configured to cause the apparatus to perform:
configuring a physical random access channel (PRACH) occasion corresponding to a user equipment (UE) at least by one of the following:
configuring a set of parameters; and
calculating a radio network temporary identifier (RNTI) based on the set of parameters or the PRACH occasion in which a random access preamble is transmitted.

31. The apparatus according to claim 30, wherein:
the RNTI comprises at least one of the following:
a random access RNTI (RA-RNTI) corresponding to a 4-step random access (RA) process, or
a MSGB-RNTI corresponding to a 2-step RA process.

32. The apparatus according to claim 30, wherein:
the set of parameters comprising an index corresponding to the PRACH occasion in which the random access preamble is transmitted and at least one of the following:
at least one least significant bit (LSB) of a system frame number (SFN); or
a segment index.

33. A non-transitory computer program product comprising a computer-readable program medium storing instructions, wherein, the instructions, when executed by a processor, are configured to cause the processor to perform:
configuring a physical random access channel (PRACH) occasion corresponding to a user equipment (UE) at least by one of the following:
configuring a set of parameters; and
calculating a radio network temporary identifier (RNTI) based on the set of parameters or the PRACH occasion in which a random access preamble is transmitted.
